(19) United States
(12) Patent Application Publication
(10) Pub. No.: US 2010/0233318 A1
(43) Pub. Date: Sep. 16, 2010

(54) PROCESS FOR THE HYDROLYSIS OF MILK PROTEINS

(76) Inventor: Luppo Edens, Rotterdam (NL)

Correspondence Address: NIXON & VANDERHYE, PC, 901 NORTH GLEBE ROAD, 11TH FLOOR, ARLINGTON, VA, 22203, US

(21) Appl. No.: 12/295,005

(22) PCT Filed: Apr. 2, 2007
(86) PCT No.: PCT/EP2007/053160

§ 371 Date: Sep. 29, 2008

(30) Foreign Application Priority Data
Mar. 31, 2006 (EP) 06112099.4

(51) Int. Cl. A23L 1/305; A23L 1/29; A23J 3/34

(52) U.S. Cl. 426/41; 426/42; 426/580; 426/583

(57) ABSTRACT

The present invention provides a composition based on comprising hydrolyzed whey protein and hydrolyzed casein protein in a ratio of between 4:1 to 4:6 (dry weight), preferably the whey protein to casein protein ratio is of between 3:1 to 1:1, more preferably the whey protein to casein protein ratio is of between 2:1 to 1:1 and most preferably this ratio is 3:2.

### FIELD OF THE INVENTION

The present invention relates to compositions comprising hydrolyzed milk casein and hydrolyzed whey protein and in particular to novel processes for the production of novel hydrolysates comprising hydrolyzed casein and hydrolyzed whey protein. The novel hydrolysates can be used in the manufacture of beverages such as sports drinks and soft drinks, dietetic products, infant nutrition products or various food products or fermented products.

### BACKGROUND OF THE INVENTION

Milk proteins consists of a casein and a whey protein fraction. The casein fraction is the main source of amino acids, calcium and phosphate all of which are required for growth of the newborn. The whey protein fraction also is a source of amino acids and in addition it contains several bioactive and putative health promoting proteins such as immunoglobulins, folate binding protein, lactoferrin, lactoperoxidase and lysozyme. Cow milk proteins represent valuable products that are being used in many different food applications. Whereas adults rarely exhibit bovine milk allergies, such milk allergies are quite common among infants. Cow milk allergy is often encountered during the first months of life and within a week after the introduction of cow milk. Eventually 2-7.5% of new born infants develop a cow milk allergy. The caseins and the beta-lactoglobulin from whey form the major cow milk allergens. For example, anti-beta-lactoglobulin IgE's were detected in 60-80% of patients allergic to cow milk. Beta-lactoglobulin, the major whey protein of cow milk, is not present in human breast milk.

Because cow milk allergy among infants is relatively common, it is not surprising that specialised infant formula products have been developed containing hydrolyzed cow milk proteins. As a result of the enzymatic hydrolysis, antigenic cow milk epitopes are destroyed hereby reducing potential allergenic reactions. To accommodate the needs of the various groups of allergic individuals, various formula are being marketed incorporating cow milk proteins hydrolyzed to different extents. Relatively new are prophylactic products aimed at minimising the risks of developing a cow milk allergy. Such products contain protein hydrolysates with low degrees of hydrolysis (DH) and are intended to slowly accustom the immune system of infants to cow milk antigens. Ideally such prophylactic products should contain hydrolyzed caseins as well as hydrolyzed whey proteins and should provide a good taste and exhibit good shelf stabilities. In order to mimic human milk as closely as possible, the whey to casein ratio present in cow milk also should be adapted. Because human milk contains a substantially larger whey protein fraction than cow milk, cow milk proteins are ideally topped up with additional whey proteins.

In U.S. Pat. No. 5,405,637 it is explained that for infant formula the whey to casein ratio of cow's milk can be altered to obtain a ratio that is close to mother's milk. This US patent also explains that infant formulas with a reduced cow milk allergenicity can be obtained by partially hydrolysing the milk proteins. A partial hydrolysate having a DH (degree of hydrysis) of between 4 and 10% was found to be very suitable for infant formulas. A great advantage of a low DH is that the hydrolysate does not becomes bitter as is the case with hydrolysates based on casein and having a high DH.

The gastro-intestinal digestion and subsequent assimilation of dietary proteins is a very efficient process. After ingestion and swallowing of proteinaceous foodstuff, it reaches the stomach where it is mixed with acid and the endoproteases pepsin and chymosin. Whereas adults secrete mainly pepsins, chymosin represents a major gastric protease in newborn. Although both proteases are socalled aspartic proteases, their cleavage patterns are completely different. Pepsin is a relatively broad spectrum protease, preferably cleaving peptide bonds involving hydrophobic amino acid residues Chymosin is a highly selective enzyme, cleaving kappa casein at one specific peptide bond hereby initiating the clotting of casein. Occasional opening of the pyloris allows the acidified and partly hydrolyzed food to flow from the stomach into the small intestine. In the first part of the small intestine i.e. in the duodenum, the pH of the stomach contents is raised by bicarbonate and bile as well as pancreatic juice are added. The pancreatic juice contains an additional set of proteases, i.e. the endoproteases trypsin, chymotrypsin and elastase as well as carboxypeptidases to further degrade the peptides and polypeptides present. The peptides and free amino acids formed are absorbed mainly in the duodenum and the jejunum.

In contrast with the whey proteins beta-lactoglobuline and alpha-lactalbumine, the casein fraction is rich in hydrophobic amino acids. Due the presence of these hydrophobic peptides, casein hydrolysates tend to be notoriously bitter and easily precipitate from the aqueous solution. Due to these difficulties, enzymatically hydrolyzed caseins find limited application only. In view of these organoleptic disadvantages of casein hydrolysates, it is not surprising that there exists considerable literature regarding the exhaustive enzymatic digestion of whey hydrolysates aimed at clinical, dietetic and sports applications as well as infant nutrition.

Nowadays the protein part of infant formula is often based on cow's milk proteins. However, cow's milk differs in several aspects from human mother's milk. Whereas children often have no problems, for example allergenicity problems, with the consumption of cow's milk, babies, on the other hand, are much more receptive for allergenicity issues created by the consumption of cow's milk. Not only certain compounds of cow's milk might give allergenic reactions, but also their digestive capacities are not suited for cow's milk. Especially newborns lack the capacity to break down all ingredients of cow's milk. One reason for this could be that because of their limited hydrolytic capacity, protective bioactives and health promoting proteins as present in the whey protein fraction, can survive the digestion process. Another, more obvious reason is that their digestive capacities are developed for consuming mother's milk and not for cow's milk. One difference in mother's milk and cow's milk can be found in the different ratio between the casein and whey proteins. Moreover cow's milk contains compounds, for example beta-lactoglobulin, which are not present in mother's milk.

### SUMMARY OF THE INVENTION

The present invention provides a composition based on a hydrolyzed whey protein containing fraction and a hydrolyzed casein protein containing fraction whereby the ratio of whey protein to casein protein is between 4:1 to 4:6 (dry weight), preferably the whey protein to casein protein ratio is of between 3:1 to 1:1, more preferably the whey protein to casein protein ratio is of between 2:1 to 1:1 and most preferably this ratio is 3:2. The casein and whey proteins used in producing the composition of the invention originate from cow's milk. The hydrolyzed casein protein containing fraction present in the composition of the invention is hydrolyzed to a DH of at least 15, preferably at least 20, more preferably at least 25. In general the DH of the hydrolyzed casein protein containing fraction will less than 40, preferably less than 35. At least part of the whey protein is used non-hydrolyzed or hydrolyzed separately from the casein protein containing fraction. The separately hydrolyzed whey protein containing fraction is preferably hydrolyzed to a DH of between 3 and 20, more preferably to a DH of between 5 and 15. Preferably the whey is hydrolysed by a suitable enzyme or enzymes to obtain whey protein comprising lactoglobulin wherein the ratio of the intensity of the SDS-PAGE protein bands representing beta-lactoglobulin and alpha-lactalbumin is at least 3:1, preferably at least 4:1, more preferably at least 10:1 and most preferably at least 50:1.

The present invention also relates to a process to produce the composition of the invention. According to this process at least part of the starting whey proteins from cow's milk are added separately. These starting whey proteins may be used non-hydrolyzed or hydrolyzed. If hydrolyzed, they are hydrolyzed separately from the casein containing fraction. The casein protein containing fraction is hydrolyzed to a DH of at least 15, preferably at least 20 and most preferably at least 25. In general the DH of the hydrolyzed casein protein containing fraction will less than 40, preferably less than 35. The separately hydrolyzed whey protein containing fraction is preferably hydrolyzed to a DH of between 3 and 20, more preferably to a DH of between 5 and 15.

The present invention also provides a product comprising a composition of the invention. This product can be a liquid such as a liquid infant formula product or a beverage such as a sports drink or a soft drink or a health drink. This product also can be a dry product such as a dietetic food, a product for elderly or a slimming product or an infant formula such as a term or follow-on product. The composition of the present invention is especially suitable for use in infant formula. Moreover it can be a a fermented product or it can be incorporated into various personal care products.

### DETAILED DESCRIPTION OF THE INVENTION

The present invention relates to a process to produce a composition comprising hydrolyzed whey protein and hydrolyzed casein protein whereby the ratio of whey protein to casein protein is between 4:1 to 4:6 (dry weight), preferably the whey protein to casein protein ratio is of between 3:1 to 1:1, more preferably the whey protein to casein protein ratio is of between 2:1 to 1:1 and most preferably this ratio is 3:2 which comprises hydrolysing a casein protein containing fraction to a DH of at least 15, preferably at least 20, more preferably at least 25, and hydrolysing a whey protein containing fraction separately from the hydrolysis of the casein protein containing fraction, preferably to a DH of between 3 and 20, more preferably to a DH of between 5 and 20 and combining the hydrolyzed casein containing fraction and the hydrolyzed whey containing fraction. In general the DH of the hydrolyzed casein protein containing fraction will be less than 40, preferably less than 35. Preferably the whey protein containing fraction is hydrolyzed by an aspartyl protease. The casein containing fraction is preferably hydrolyzed by a subtilisin (EC3.4.21.62) and/or proline-specific endoproteases such as prolyl oligopeptidase (EC 3.4.21.26), the proline-specific endoprotease from A. niger (WO 02/45524) or a proline-specific dipeptidyl peptidase such as DPP IV (EC 3.4.14.5) are preferred.

The present invention also relates to a composition comprising a hydrolyzed whey protein and a hydrolyzed casein protein whereby the ratio of whey protein to casein protein is between 4:1 to 4:6 (dry weight) in the composition, preferably the whey protein to casein protein ratio is of between 3:1 to 1:1, more preferably the whey protein to casein protein ratio is of between 2:1 to 1:1 and most preferably this ratio is 3:2 and whereby the hydrolyzed casein is hydrolyzed to a DH of at least 15, preferably at least 20, and more preferably at least 25 and the hydrolyzed whey is preferably hydrolyzed to a DH of between 3 and 20, more preferably to a DH of between 5 and 20. In general the DH of the hydrolyzed casein will less than 40, preferably less than 35.

According to another aspect of the present invention a product comprising the composition of the invention is a beverage such as a sports drink, a soft drink or a health drink, or a food, preferably a dietetic food, such as a product for elderly or for slimming people or an infant formula such as a term or follow-on product. Preferably this product is an infant formula.

Important idea underlying the present invention are that the final product contains casein as well as whey protein. This is noteworthy because the majority of the cow milk hydrolysates currently on the market contain either caseins or whey proteins and not a mixture of caseins and whey proteins and certainly no caseins hydrolyzed to the extent reported here. Another important aspect is that the product according to the invention is that protective bioactives and health promoting proteins as present in the whey protein fraction are left intact and that the product according to the invention contains a whey protein to casein ratio similar to the ratio present in human milk. Yet another problem solved by the present invention is that as a result of its limited DH, only the whey protein fraction is used to stimulate the build up of a natural immunoresponse against cow milk. The whey protein fraction is preferably hydrolyzed with an endoprotease and under pH conditions that leave the beta-lactoglobulin fraction largely intact. So according to one aspect of the invention the beta-lactoglobulin is used to build up the natural immunoresponse against cow's milk. Because under these conditions the alpha-lactalbumin fraction of the whey proteins is cleaved, the high tryptoptophane content of the alpha-lactalbumin fraction is readily incorporated into the blood stream hereby adding to the beneficial effects of tryptophane on conscious behaviour and sleep patterns of the infant. Therefore according to the invention a composition, preferably an infant formula, is disclosed comprising casein protein and whey protein whereby the ratio of whey protein to casein protein is between 4:1 to 4:6 (dry weight), preferably the whey protein to casein protein ratio is of between 3:1 to 1:1, more preferably the whey protein to casein protein ratio is of between 2:1 to 1:1 and most preferably this ratio is 3:2, and comprising lactoglobulin whereby the ratio of the intensity of the SDS-PAGE protein bands representing beta-lactoglobulin and alpha-lactalbumin is at least 3:1, preferably at least 4:1, more preferably at least 10:1 and most preferably at least 50:1 (the ratio of the intensity of the protein bands representing the beta-lactoglobulin and the alpha-lactalbumin is determined with SDS-PAGE as described in the Materials and Methods). This composition, comprising a whey protein and a casein protein whereby the ratio of whey protein to casein protein is between 4:1 to 4:6 (dry weight) in the composition, preferably the whey protein to casein protein ratio is of between 3:1 to 1:1, more preferably the whey protein to casein protein ratio is of between 2:1 to 1:1 and most preferably this ratio is 3:2, and comprising lactoglobulin whereby the ratio of the intensity of the SDS-PAGE protein bands representing beta-lactoglobulin and alpha-lactalbumin is at least 3:1, preferably at least 4:1, more preferably at least 10:1 and most preferably at least 50:1 (the ratio of the intensity of the protein bands representing the beta-lactoglobulin and the alpha-lactalbumin is determined with SDS-PAGE as described in the Materials and Methods), comprises preferably hydrolysed casein protein and hydrolysed whey protein and whereby the casein is hydrolyzed to a DH of at least 4, preferably at least 8, more preferably at least 15, even more preferably at least 20 and the hydrolyzed whey is preferably hydrolyzed to a DH of between 3 and 20, more preferably to a DH of between 5 and 20.

Preferably the composition of the invention is a turbid liquid at pH 4 when the hydrolysed casein protein and whey protein are dissolved or present in water in an amount of 40 g of protein (dry weight)/litre at 10° C.

In case the protein composition comprises less than 40 g of protein (dry weight)/litre, this composition is a turbid liquid at 10 degrees C. when concentrated to a liquid of 40 g of protein (dry weight)/litre.

A liquid composition is “turbid” if at 10° C. and pH4 its optical absorption measured at 480 nanometer and using a 1cm glass cell is higher than 1.00, preferably higher than 1.25, when measured against a supernatant of the same composition at 10° C. and pH4 that has been obtained after a centrifugation at 20,000 g for 20 minutes.

According aspect of the invention relates to whey protein comprising lactoglobulin wherein the ratio of the intensity of the SDS-PAGE protein bands representing beta-lactoglobulin and the alpha-lactalbumin is at least 3:1, preferably at least 4:1, more preferably at least 10:1 and most preferably at least 50:1(the ratio of the intensity of the protein bands representing the beta-lactoglobulin and the alpha-lactalbumin is determined with SDS-PAGE as described in the Materials and Methods).

Preferably this whey protein is hydrolyzed to a DH of between 3 and 20, more preferably to a DH of between 5 and 20. Also compositions comprising this whey protein are part of the present invention.

As a result of the extensive hydrolysis required to achieve the proper organoleptical and shelf stability properties of the casein fraction, the casein fraction of the product according to the invention is hypoallergenic. This is quite similar to the natural situation in infants in which caseins have shown a greater breakdown than the whey proteins (Hamosh, M., Neonatal Gastroenterology, 1996, 23,2:191-209).

The composition according to the invention preferably comprises hydrolysates of whey protein and casein protein in ratios comparable to the ratios present in human mother's milk. The starting protein is obtained from cow's milk. Cow's milk protein consists for approximately 80% of casein protein and 20% of whey protein. Mother's milk protein consists for approximately 40% of casein and 60% of whey. In order to increase the whey protein content of cow's milk, additional whey protein is added during the production of the composition according to the present invention. This added whey protein can be added as a hydrolyzed or a non-hydrolyzed product.

Generally there are two different methods to obtain the desired whey protein to casein protein ratio in the composition of the present invention. According to the first method cow's milk, preferably skimmed cow's milk, i.e. including its whey protein fraction, is hydrolyzed to obtain the casein protein containing fraction or the casein containing fraction of the product according to the invention. Then an additional whey protein fraction is added to this hydrolyzed cow milk fraction to obtain a whey to casein ratio similar to the ratio found in human milk. According to the second method, casein or caseinate is used as starting composition to make the hydrolyzed casein protein containing fraction. For this process the casein is first separated from the cow milk via an acid or an enzymatic clotting process. Many of such separation processes are described in detail in the prior art. The casein or caseinate thus obtained, is then subjected to an enzymatic hydrolysis process to obtain the desired high DH values. To obtain the desired whey protein to casein protein ratio according to this second method, additional whey protein is added to this hydrolyzed casein or caseinate fraction. Also here the additional whey protein may be hydrolyzed or non-hydrolyzed. Of course also a mixture of cow's milk and casein protein can be used to make the hydrolyzed casein containing protein fraction which is hydrolyzed according to the process of the invention.

The idea underlying the present invention is that the product according to the invention contains at least partially a whey protein, hereinafter called the whey containing fraction or the whey protein containing fraction, that is hydrolyzed in a different way than the casein protein containing fraction. Whereas the whey protein containing fraction contains essentially no casein, the casein protein containing fraction contains casein and may also contain whey protein. By essentially no casein is meant that less than 10 wt %, preferably less than 5 wt %, of the sum of the casein protein and the whey protein, is casein protein. The amount of the whey protein and casein in the casein protein containing fraction is therefore between 100% casein and 82% casein plus 18% whey protein, i.e. as in cow's milk. As described above, the casein protein containing fraction can be cow's milk, preferably skimmed milk, casein, caseinate or a mixture of these compounds. The whey protein containing fraction may originate from a whey obtained from cheese making, especially the whey obtained from coagulation of casein by using a rennet is very suitable in the present process.

To take advantage of the process of the invention, the enzymatic hydrolysis of the whey protein containing fraction results in a hydrolysate of a DH of between 3 and 20, more preferably to a DH of between 5 and 15. Preferably hydrolysis of the whey protein containing fraction is carried out with an endoprotease that leaves a part of the beta-lactoglobulin moiety of the whey fraction of cow milk intact. More preferably this hydrolysis is carried out under acid conditions, preferably at pH 5 or lower, using an aspartic endoprotease (EC 3.4.23).

Enzymatic hydrolysis of the casein protein containing fraction is done by a sufficient amount of enzymes for a sufficient period of time to become an almost completely hydrolyzed protein. The DH of the casein fraction thus obtained is typically 25 or higher. Preferably this hydrolysis is carried out using a hydrolysis process involving a proline specific protease.

A “peptide” or “oligopeptide” is defined herein as a chain of at least two amino acids that are linked through peptide bonds. The terms “peptide” and “oligopeptide” are considered synonymous (as is commonly recognized) and each term can be used interchangeably as the context requires. A “polypeptide” is defined herein as a chain containing more than 30 amino acid residues. All (oligo)peptide and polypeptide formulas or sequences herein are written from left to right in the direction from amino-terminus to carboxy-terminus, in accordance with common practice. A protein is defined as used herein as the non-hydrolyzed whey and casein protein. Moreover, especially when the ratio of whey and casein protein is discussed, protein can also mean hydrolyzed protein.

The one-letter and three-letter code of amino acids used herein is commonly known in the art and can be found in Sambrook, et al. (Molecular Cloning: A Laboratory Manual, 2nd, ed. Cold Spring Harbor Laboratory, Cold Spring Harbor Laboratory Press, Cold Spring Harbor, N.Y., 1989). An endoprotease is defined herein as an enzyme that hydrolyses peptide bonds in a polypeptide in an endo-fasion and belongs to the group EC 3.4. The endoproteases are divided into sub-subclasses on the basis of catalytic mechanism. There are sub-subclasses of serine endoproteases (EC 3.4.21), cysteine endoproteases (EC 3.4.22), aspartic endoproteases (EC 3.4.23), metalloendoproteases (EC 3.4.24) and threonine endoproteases (EC 3.4.25). Exoproteases are defined herein as enzymes that hydrolyze peptide bonds adjacent to a terminal α-amino group (“aminopeptidases”), or a peptide bond between the terminal carboxyl group and the penultimate amino acid (“carboxypeptidases”).

The present invention provides a milk protein hydrolysate, preferably having a whey to casein ratio of between 4:1 and 4:6 dry weight, preferably in a ratio as present in mother's milk. Moreover the present invention provides a method of production of such a milk protein hydrolysate and nutritional products derived thereof. The protein hydrolysate can also be used in powdered or liquid infant formulae, dietetic foods, nutraceuticals, ice creams, dressings, fermented products, yoghurts, and personal care products. In general the composition according to the invention has a strongly reduced allergenicity compared with bovine milk. In general the composition according to the invention has a bland or neutral taste and an improved solubility under acid conditions and can be used as basis for other beverages such as sport drinks or soft drinks or health drinks or fermented products. By the term bland taste of a composition or product of the invention is meant that the bitterness level of a 3 wt % protein in water sample, is similar to or lower than a level of 15 mg/litre of quinine sulphate dissolved in distilled water and tasted at a temperature of 14° C.

The term nutraceutical as used herein denotes the usefulness in both the nutritional and pharmaceutical field of application. Thus, novel nutraceutical compositions comprising the composition of the invention can find use as supplement to food and beverages and as pharmaceutical formulations or medicaments for enteral or parenteral application which may be solid formulations such as capsules or tablets, or liquid formulations, such as solutions, suspensions or emulsions.

To further improve the health benefits of the product of the present invention, the protein composition can be combined with vitamin concentrates, fruit or fruit fractions to lift the vitamin and fiber contents of the final product and even hydrolysate fractions to lift the level of bioactive or tryptophane containing peptides. Moreover the product of the invention can be fermented with a variety of microbial cultures to improve the taste, to improve the health benefits or to increase the viscosity of the final product.

To gain a broad consumer acceptance among consumers with non-medical needs, a high palatability as well as certain physico-chemical aspects such as solubility under acid conditions are of overriding importance.

The method of production of hydrolysates according to the invention may be carried out by using skimmed milk, skimmed milk powders, milk protein concentrates, mixtures of whey protein and casein in preferred ratios as the source of the casein protein containing fraction, as starting materials for hydrolysis.

Skimmed milk is cow's milk which is defatted and thus contains preferably less than 1 g/litre of fat, preferably less than 0.8 g/litre of fat. In the product casein containing fraction according to the invention using casein, skim milk or skim milk powder as the starting material, the peptide fraction with a molecular weight below 500 Daltons typically represents more than 70 wt % of the protein present in the composition of the invention whereas the peptide fraction below 5000 Daltons typically represents more than 95 wt % of the protein present in the composition of the invention. Therefore, the products according to the invention will preferably exhibit a markedly reduced allergenicity compared to the starting protein. The invention also envisages hydrolysates with lowered osmotic values such as can be obtained after nanofiltration, ion exchange or electro dialysis.

The whey proteins may be sourced from liquid whey obtained from cheese making, preferably a sweet whey such as that resulting from the coagulation of casein by an animal or microbial rennet which is further purified from contaminating caseins, for example by acidification followed by centrifugation. Preferably concentrated, non-spray dried versions of these whey products are used. Optionally commercially available whey protein powders may be used such as BiPRO (Davisco Foods International), PROXIME 660 or HIPROTAL 875 or DOMOVICTUS 535 (BDI, The Netherlands) or more preferably their non-spray dried equivalents. Optionally the whey used may have been subjected to non-proteolytic enzymes such as lactase to convert the lactose present into glucose and galactose. Optionally the whey material may have been demineralised.

The present invention preferably envisages hydrolysis of the whey protein containing fraction to a DH of between 3 and 20, more preferably to a DH of between 5 and 15. For the hydrolysis of the whey protein containing fraction, preferably an endoprotease is used under conditions that selectively cleaves the alpha-lactalbumin fraction of the whey proteins. More preferably an aspartic endoprotease is used under acid incubation conditions. Examples of suitable aspartyl proteases are pepsin, the aspartyl protease as secreted by Rhizomucor (EC 3.4.23) or aspartyl proteases secreted by Aspergillus niger. As illustrated in Example 3 of the present invention, the use of aspartyl proteases surprisingly resulted in a hydrolyzed whey protein wherein specifically the alpha-lactalbumine was hydrolyzed.

Beta-lactaglobulin is not part of mother's milk and therefore is found advantageously to improve the antigenic response of infants against cow milk. The use of aspartic endoproteases hardly affects the beta-lactaglobulin fraction and yields whey fraction hydrolysates with low DH values and thus several larger protein fragments. These whey fraction hydrolysates are found to be especially suitable to strengthen the immune system and provide the bioactive peptides and proteins as well as nourishment for new-borns or babies. This strengthening of the immune system and adapting the immune system to recognizing the beta-lactoglobulin as being harmless, is very advantageous for the future of these newborns or babies. If the immune system is not correctly functioning it might start reacting against proteins found in cow's milk which may lead to cow's milk allergy. For this reason the balance of beta-lactaglobulin in combination with only partially hydrolyzed whey proteins results in an important and advantageous improvement of the composition of the invention, compared to infant formula based on hydrolysates as presently on the market, making the present composition so very suitable as infant formula for new-borns and babies. Using the composition of the present invention reduces the risk that the immune system of new-borns or babies will respond to one or more of the proteins found in cow's milk. This represents an important advantage, not only at the age where infant formula are being used, but also at a later age, for example as a young kid. In this way milk allergy, which is the immune system's response to one or more of the proteins found in cow's milk, might be prevented in many cases.

Another additional advantage of the present process of the invention is that the hydrolysis of the whey containing fraction according to the invention results in improved emulsifying properties. Beta-lactoglobulin largely survives the hydrolysis conditions according to the invention and it is well known that especially beta-lactoglobulin has significant emulsion stabilizing properties. Moreover, the aspartic endoproteases used preferentially cleave peptide bonds involving a hydrophobic amino acid residue such as Phe, Leu, Tyr or Val, hereby adding to the emulsifying and thus product stabilizing effect of the whey derived proteins and peptides. The latter aspect is of particular relevance for liquid products as the presence of inherent emulsifying properties prevents or at least reduces the need for adding (non-milk) emulsifiers.

To obtain hydrolysates of the casein protein containing fraction, the proteins are subjected to an endoprotease with a pH optimum between 4 and 10 and a preference for cleaving proteins at the carboxyterminal side of bulky, hydrophobic amino acid residues. Preferably the endoprotease is free of exoprotease.

Preferred endoproteases with such characteristics are serine endoproteases (EC 3.4.21). Examples of such serine endoproteases are Pescalase as supplied by DSM Food Specialities, Seclin, France, or Alcalase as supplied by Novozymes, Bagsvaerd, Denmark. Alternatively metalloproteases (EC 3.4.24) such as Thermoase as supplied by Daiwa Kasei, Osaka, Japan, or Brewers Protease 2000 as supplied by DSM Food Specialities, Seclin, France, or Neutrase as supplied by Novozymes) or chymotrypsin (EC 3.4.21.1) can be used. Preferably additional to this endoprotease a proline-specific endoprotease or proline-specific endopeptidase or a proline-specific dipeptidyl peptidase such as DPP IV (EC 3.4.14.5) is used. A proline specific protease can imply preferential cleavage at either the aminoterminal or the carboxyterminal side of proline. Endoproteases capable of cleaving at the aminoterminal side of proline are known (Nature, Vol 391, 15 January 15, pp 301-304, 1998). Endoproteases with a preference for cleaving at the carboxyterminal side of proline are also known (EC 3.4.21.26). The latter type of proline-specific endoprotease is preferably obtained from food-grade overproducing recombinant strains such as Aspergillus. An example of a suitable producer of this enzyme has been described in WO 02/45524. As this proline-specific endoprotease can only hydrolyse peptide bonds involving proline residues, this enzyme can advantageously be combined with one of the preferred endoproteases to hydrolyse the combined whey protein and casein or the isolated fractions. An important advantage of using a proline specific protease is that it is capable of cleaving major allergenic epitopes in caseins. For example, casein is very rich in proline residues and thus can be frequently cut by the proline specific endoprotease A preferred embodiment of the process according to the invention is that the casein protein containing fraction is subjected to hydrolysis involving at least a proline-specific protease.

Another preferred embodiment of the process according to the invention is that the enzymatic hydrolysis of the whey protein containing fraction and/or the casein protein containing fraction is hydrolyzed with the use of endoproteases only i.e. without the use of any exoproteases.

Depending on the pH optimum of the proline-specific protease, the hydrolysis can be carried out in combination with or separate from the other endoprotease. The hydrolysis can be carried out under constant pH or uncontrolled pH conditions. Preferably hydrolysis of the casein containing fraction is carried out in two steps, firstly the proteins are incubated under neutral or alkaline conditions with an endoprotease with a preference for cleaving proteins at the carboxyterminal side of bulky, hydrophobic amino acid residues. During this hydrolysis the pH drops to acidic values (i.e. below pH 7) and only then the second endoprotease is added, preferably a proline-specific protease, more preferably a proline-specific endoprotease, even more preferably a proline specific endoprotease obtained from Aspergillus.

The quantity of enzyme required to achieve the desired degree of hydrolysis depends upon the enzyme used. However, the enzyme dosage and incubation conditions are optimised in such a way so that the majority of the casein protein fraction is dissolved in the aqueous phase of the reaction after incubation periods of typically 6 to 20 hours. By majority is meant that under pH 4, less than 20%, preferably less than 10%, more preferably less than 5% of the protein present in the casein fraction can be precipitated upon centrifugation for 10 minutes at 2000 g.

Irrespective of the conditions of the hydrolysis, the final hydrolysate of the casein protein containing fraction as well as the whey protein containing fraction preferably is subjected to an additional step of enzyme inactivation. The enzyme inactivation step can be a heat treatment which comprises heating to a temperature of at least 85° C. for at least 10 minutes. If higher temperatures or more extreme pH values are used, shorter periods may be feasible. Such heat treatment is preferably carried out at an acidic pH value, preferably between 3 and 7. The enzyme inactivation treatment can be done for both fractions seperately or can be done after that the fractions are mixed to form the composition of the invention. Optionally, to remove non solubilised material from the final product, decantation or low speed centrifugation at for example 2000-4000 g as can be carried out at industrial scale, is preferred. Optionally each hydrolysate or the mixture of both hydrolysates can be filtered using for example diatomaceous earth or fiberglass filters. Complete enzyme inactivation can be confirmed by a dye-gelatin test.

Optionally the filtered final hydrolysate(s) can be treated with activated charcoal or with nanofiltration, ion exchange or electro dialysis to remove a surplus of salts. The filtered hydrolysate(s) can be pasteurised or sterilised and, if required, further concentrated by drying techniques such as evaporation, nano filtration, spray drying, fluidized bed drying or combinations thereof. Preferably the obtained product is in a granular form.

In a preferred embodiment of the invention the casein protein containing fraction is hydrolyzed with an endoprotease and then preferably subjected to incubation with a proline specific endoprotease. As such or preferably after centrifugation, the hydrolyzed casein protein containing fraction can be concentrated and dried. The dried product can be redissolved in the hydrolyzed whey protein containing fraction to obtain the desired protein concentration and protein ratio and then, if required, centrifuged or filtered and pasteurised or sterilised to obtain the product according to the invention. Alternatively the concentrated hydrolysate of the casein protein containing fraction is mixed with the concentrated, hydrolyzed whey protein containing fraction to reach the desired protein concentration and protein ratio and then optionally centrifuged or filtered and optionally pasteurised or sterilised to obtain the composition according to the invention.

Obviously the product can be subjected to additional enzyme treatments such as lactases or can be fermented with different types of starter cultures or can be combined with all kinds of ingredients such as oils, fats, emulsifyers, carbohydrates, fruit concentrates, flavours, colorants, alcohol, carbon dioxide, thickeners, acidulants, antioxidants, herbs or herb extracts, health promoting compounds like vitamins or provitamins or bioactive or tryptophane containing peptides or amino acids to formulate a product which is in line with the marketing needs.

### LEGEND TO THE FIGURE

FIG. 1: SDS-PAGE analysis of whey proteins incubated with pepsin at 37 degrees C. and pH 5.0. Lane A: Pepsin reference in a concentration of 1 mg/ml. Lane B: whey proteins in a concentration of 1 mg/ml. According to the molecular weights of the various protein bands, the lowest band with a molecular weight of approx. 14 kDa is alpha-lactalbumine and the more prominent band with a molecular weight of approx. 18 kDa is beta-lactoglobuline. Lane C: Whey proteins incubated with pepsin for 90 minutes at 37 degrees C. and pH 5.0. Evidently all proteins present in the whey protein fraction are hydrolyzed; only beta-lactoglobuline and pepsin are still present as intact molecules.

### MATERIALS AND METHODS

### Materials.

Edible potassium caseinate spray (88%) was obtained from DMV International, The Netherlands. Skim milk from Campina, The Netherlands was obtained from a local supermarket. Whey protein (BIPRO) was obtained from Davisco (US). Pepsin from porcine stomach mucosa, 2331 U/mg, was obtained from Sigma.

Proline-Specific Endoprotease From A. niger

Overproduction and chromatographic purification of the proline specific endoprotease from Aspergillus niger was accomplished as described in WO 02/45524. The A. niger proline specific endoprotease activity was tested using CBZ-Gly-Pro-pNA (Bachem, Bubendorf, Switzerland) as a substrate at 37° C. in a citrate/disodium phosphate buffer pH 4.6. The reaction products were monitored spectrophotometrically at 405 nM. The increase in absorbance at 405 nm in time is a measure for enzyme activity. A Proline Protease Unit (PPU) is defined as the quantity of enzyme that releases 1 μmol of p-nitroanilide per minute under the conditions specified and at a substrate concentration of 0.37 mM Z-Gly-Pro-pNA.

### Degree of Hydrolysis

The Degree of Hydrolysis (DH) as obtained during incubation with the various protolytic mixtures was monitored using a rapid OPA test (Nielsen, P. M.; Petersen, D.; Dambmann, C. Improved method for determining food protein degree of hydrolysis. Journal of Food Science 2001, 66, 642-646).

### Sensoric Evaluations

Sensoric evaluations of the protein hydrolysates formed were carried out by an independent institute availing of a panel trained in detecting and ranking various levels of bitterness. During the sessions the taste trials were performed ‘blind’ and bitterness was scored on a scale from 0 (none)-4 (very bitter). Panel members were trained with quinine sulphate with the following solutions:
15 ppm quinine sulphate>Intensity bitter=1
20 ppm quinine sulphate>Intensity bitter=2
30 ppm quinine sulphate>Intensity bitter=3
50 ppm quinine sulphate>Intensity bitter=4
   The taste of the hydrolysates was evaluated using protein concentrations of 3% (w/w) in water. The pH of the four solutions was adjusted to 4.0 and the temperature to 14° C. A reference sample of 15 mg/L quinine sulphate was given to the panelists before the taste session and was assigned a bitter intensity value of 1.

### SDS-PAGE

All materials used for SDS-PAGE and staining were purchased from Invitrogen (Carlsbad, Calif., US). Samples were prepared using SDS buffer according to manufacturers instructions and separated on 12% Bis-Tris gels using MES-SDS buffer system according to manufacturers instructions. Staining was performed using Simply Blue Safe Stain (Collodial Coomassie G250). To obtain quantitative information on the beta-lactoglobulin to alpha-lactalbumin ratio, first a digital image (OptiGo, IsogenLife Science: Ijsselstein, The Netherlands) was obtained from the gels which was then analysed using Totallab, TL100 (Nonlinear Dynamics LTD, www.nonlinear.com) image analysis software.

### EXAMPLE 1

### Non-Bitter Skim Milk Hydrolysates

Skim milk with a protein content of approximately 4% (w/w) is subjected to a two-step enzymatic hydrolysis. In the first step, the skim milk is incubated with the serine endoprotease Protex AF (Genencor, Leiden, The Netherlands). Incubation takes place at the natural milk pH at 60 degrees C. using 25 ml of enzyme per kg of protein. After 4 hours of incubation, the pH is lowered to 4.5 and 1 PPU of proline-specific endoprotease/gram of protein is added. The incubation is continued for another 9 hours at 55 degrees C. A typical DH value at this stage is 28 and the liquid has a negligable bitterness as judged following the procedure described in the Materials & Methods section. After a brief heat shock to inactivate all enzymatic activities, the liquid is evaporated to obtain a concentrated liquid containing approximately 30% dry matter. By adding a whey protein according to the invention, a protein hydrolysate is obtained with a human whey to casein ratio.

### EXAMPLE 2

### Non-Bitter Casein Hydrolysates

Non-bitter casein hydrolysates can be obtained by following the procedure as described in Example 1. However, in this case starting point is a suspension of 10% (w/w) of caseinate. After the heat shock the enzymatic activities and the evaporation step, a powdered, non-bitter casein hydrolysate can be obtained by spraydrying of the evaporated liquid.

### EXAMPLE 3

### Pepsin Preferentially Hydrolyses Alpha-Lactalbumin

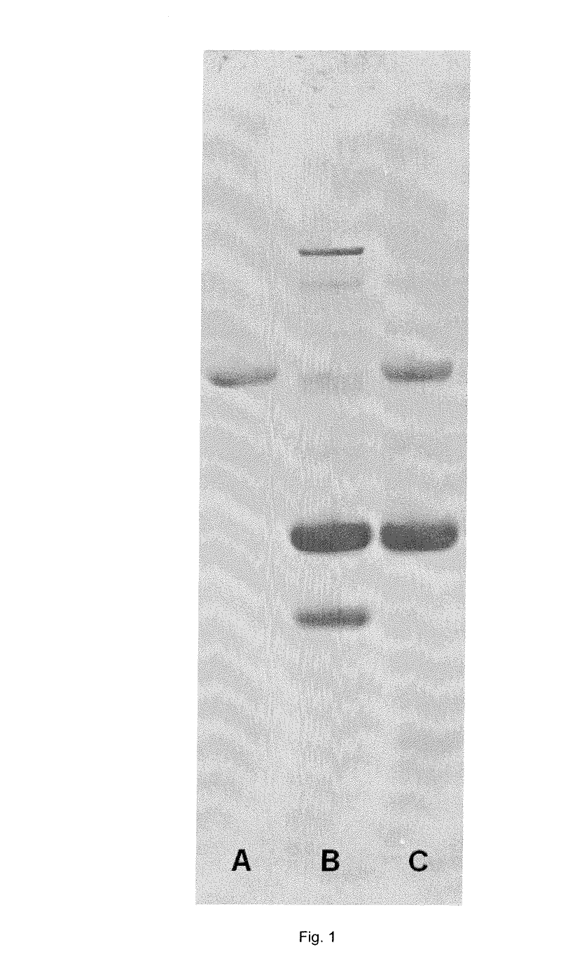

To demonstrate the preferential cleavage of alpha-lactalbumin by pepsin, a small sample of whey powder (BIPRO from Davisco, US) was incubated with pepsin from porcine stomach mucosa. To imitate the natural conditions as much as possible, the incubation took place at 37 degrees C. and at a pH of 5.0. At regular time intervals samples were taken and subjected to SDS-PAGE. The data obtained (see FIG. 1 for a typical example) clearly indicate the preferential cleavage of the alpha-lactalbumin moiety of the whey fraction. Although beta-lactoglobulin is relatively resistant to pepsin incubation, it is obvious that by using relatively high enzyme dosages this protein also can be degraded. Using the imaging and quantification method as described in the “Materials and Methods” section a beta-lactoglobulin to alpha-lactalbumin ratio of 1:2.7 was found of the whey prior to hydrolysis.

1. A process to produce a composition comprising hydrolyzed whey protein and hydrolyzed casein protein whereby the ratio of whey protein to casein protein is between 4:1 to 4:6 (dry weight), preferably the whey protein to casein protein ratio is of between 3:1 to 1:1, more preferably the whey protein to casein protein ratio is of between 2:1 to 1:1 and most preferably this ratio is 3:2 which comprises hydrolysing a casein containing fraction to a DH of at least 15, preferably at least 20, hydrolysing a whey protein containing fraction seperately from the hydrolysis of the casein protein containing fraction preferably to a DH of between 3 and 20 more preferably at least 25, more preferably to a DH of between 5 and 20 and combining the hydrolyzed casein protein containing fraction and the hydrolyzed whey protein containing fraction.

2. A process according to claim 1 wherein the whey protein containing fraction is hydrolyzed by an aspartyl protease.

3. A process according to claim 1 wherein the casein protein containing fraction is hydrolyzed by a subtilisin.

4. A process according to claim 1 wherein the casein protein containing fraction is hydrolyzed by a proline specific endoprotease.

5. A composition comprising a hydrolyzed whey protein and a hydrolyzed casein protein whereby the ratio of whey protein to casein protein is between 4:1 to 4:6 (dry weight) in the composition, preferably the whey protein to casein protein ratio is of between 3:1 to 1:1, more preferably the whey protein to casein protein ratio is of between 2:1 to 1:1 and most preferably this ratio is 3:2 and whereby the hydrolyzed casein is hydrolyzed to a DH of at least 15, preferably at least 20 and the hydrolyzed whey is preferably hydrolyzed to a DH of between 3 and 20, more preferably to a DH of between 5 and 20.

6. A composition comprising casein protein and whey protein whereby the ratio of whey protein to casein protein is between 4:1 to 4:6 (dry weight), preferably the whey protein to casein protein ratio is of between 3:1 to 1:1, more preferably the whey protein to casein protein ratio is of between 2:1 to 1:1 and most preferably this ratio is 3:2, and comprising lactoglobulin whereby the ratio of the intensity of the SDS-PAGE protein bands representing beta-lactoglobulin and the alpha-lactalbumin is at least 3:1, preferably at least 4:1, more preferably at least 10:1 and most preferably at least 50:1.

7. A composition of claim 6 which comprises hydrolysed casein protein and hydrolysed whey protein and whereby the casein is hydrolyzed to a DH of at least 4, preferably at least 8, more preferably at least 15, even more preferably at least 20 and the hydrolyzed whey is preferably hydrolyzed to a DH of between 3 and 20, more preferably to a DH of between 5 and 20.

8. A composition according to claim 5 wherein the composition is a turbid liquid at pH 4 when the casein protein and whey protein are dissolved or present in water in an amount of 40 g of protein (dry weight)/litre at 10° C.

9. A whey protein comprising lactoglobulin wherein the ratio of the intensity of the SDS-PAGE protein bands representing beta-lactoglobulin and the alpha-lactalbumin is at least 3:1, preferably at least 4:1, more preferably at least 10:1 and most preferably at least 50:1.

10. A whey protein according to claim 9 whereby the whey is hydrolyzed to a DH of between 3 and 20, more preferably to a DH of between 5 and 20.

11. A composition comprising the whey protein of claim 9.

12. A product comprising the composition of claim 5, or the whey protein which is a beverage such as a sports drink, a soft drink or a health drink, or a food, preferably a dietetic food, such as a product for elderly or for slimming people or an infant formula such as a term or follow-on product.

13. The product of claim 12 which is an infant formula.
